(19) United States
(12) Patent Application Publication
(10) Pub. No.: US 2024/0116804 A1
(43) Pub. Date: Apr. 11, 2024

(54) FIRING AID COMPOSED OF A COMPOSITE MATERIAL, COMPOSITE MATERIAL AND METHOD OF PRODUCTION THEREOF, AND USE THEREOF

(71) Applicant: SCHOTT AG, Mainz (DE)

(72) Inventors: Manfred-Josef Borens, Mainz (DE); Frank Jürgen Druschke, Mainz (DE); Peter Franke, Mainz (DE); Michael Bug, Mainz (DE); Christian Kunert, Mainz (DE); Gerald Wasem, Mainz (DE); Joachim Dietrich Kehl, Mainz (DE)

(73) Assignee: SCHOTT AG, Mainz (DE)

(21) Appl. No.: 18/479,328

(22) Filed: Oct. 2, 2023

(30) Foreign Application Priority Data
Sep. 30, 2022 (DE) 10 2022 125 253.1

(51) Int. Cl. C03C 14/00; C03B 19/06; C03C 1/00; C03C 19/00

(52) U.S. Cl. CPC C03C 14/004; C03B 19/066; C03C 1/00; C03C 19/00; C03C 2214/04; C03C 2214/30

(57) ABSTRACT

A formulation usable to produce plates and shaped bodies has a base slip, quartz glass particles and multicomponent glass particles that are crystallizable or at least partly crystallized. The base slip contains water as dispersion medium with a content between 30% and 50% by weight and ultrafine SiO₂ particles distributed, preferably colloidally therein, with a proportion between 50% and 70% by weight. The proportion of quartz glass particles in the formulation is in the range from 40% to 70% by weight and the proportion the multicomponent glass particles in the formulation is in the range from 5% to 37% by weight. The formulation can be used in a composite material. Firing aids can be made from the composite material.

### CROSS-REFERENCE TO RELATED APPLICATIONS

This application claims priority under 35 U.S.C. § 119 to German patent application 102022125253.1, filed Sep. 30, 2022, the entire disclosure of which is incorporated herein by reference.

### BACKGROUND OF THE DISCLOSURE

### 1. Field of the Disclosure

The disclosure relates generally to a composite material which is particularly suitable for use as firing aid in high-temperature shaping processes. The disclosure relates more particularly to a sintered composite material having high dimensional stability and trueness of shape.

### 2. Description of Related Art

For a multitude of postprocessing operations on for example glasses or else glass-ceramics, for example, shaping and/or supporting bases are required both for transport and for performance of the corresponding operations, and so to speak are used as firing aids, also called kiln furniture, firing auxiliaries or the like. In this context, the materials used here are sometimes exposed to harsh process conditions. For example, the materials in the ceramization of green glass articles to glass-ceramic articles are subjected to high temperatures over relatively long time intervals of several hours up to several days. The repeated use of the firing aids, depending on the respective firing aid and process, for up to several hundred uses places high demands on the firing aid. This is also true for shaping processes in which, for example, green glasses are bent and ceramized. There is also a need for corresponding firing aids in manufacturing and processing operations on ceramics or fusing processes for manufacture of glass articles.

Firing aids used at present are usually slip-cast SiO2 materials or fused silica and components produced therefrom. As a result of sustained stress on the firing aids, especially at process temperatures above 750° C., and also, in particular, the short thermal cycles in some cases in the course of heating and/or changes in temperature during the process regime, including cooling, however, such materials show variance in terms of their shape with increasing use time. This means that a corresponding mould cannot be assumed to be true to size, which has an adverse effect, for example, on the quality of the glass or glass-ceramic products produced or processed with the aid of the firing aids. In addition, there can also be a change in the contact area of the firing aid with the glass or glass-ceramic products. This can cause, for example, unevenness or surface defects of the glass or glass-ceramic products, and hence likewise have an adverse effect on product quality.

These adverse changes are caused firstly by further sintering processes and changes in the material structure of the materials used in the firing aids, especially as a result of the above-described thermal loads. For instance, the high temperatures can result in transformation of the quartz glass phases at least partly to crystalline structures. In this context, the formation of cristobalite is of particular relevance. Above 1200° C., the quartz glass is converted to cristobalite, which is associated with an increase in volume. The change in volume in the material can result in deformation of the firing aid, which in turn affects the trueness to size of the glass or glass-ceramic product. A further disadvantage of cristobalite formation is that a transformation of the cristobalite phases with increasing volume takes place in turn below 200° C., which can lead to cracking, flaking and correspondingly contamination of kilns, the firing aids themselves, and also the products, or even the failure of the firing aids.

The use of firing aids composed of essentially purely quartz-based SiO2 materials can be problematic here, especially in the case of processes with temperatures above 1000° C. For instance, these have a tendency to changes in structure under sustained stress in the high-temperature range of more than 750° C. These changes are the result of further sintering processes and transformations in the material structures, for example through transformations of glassy phases to crystalline structures, transformations of crystalline phases, or reduction in residual porosity. These changes can be associated with changes in volume and hence lead to changes in shape, so that trueness to size during the period of operation cannot be assumed. Moreover, there can also be a change in contact area with the glass products. This can lead to losses of quality in glass production or ceramization (i.e. in the transformation of glass to glass-ceramic).

In order to avoid these disadvantages, the prior art describes firing aids composed of silicon carbide (SiC), for example, which are less susceptible to the above-described changes. A disadvantage, however, is that corresponding components are very costly and are frequently unavailable in the shape and size required, of one to a few m² depending on the application. Moreover, the usually abrasive processing operation (for example grinding) for production of 3-dimensional moulds and bases, especially given very high scale demands and tight tolerances, is possible only with very great difficulty, complexity and cost.

### SUMMARY OF THE DISCLOSURE

It is therefore an object of the disclosure to provide a material which is structurally and dimensionally stable with respect to high temperatures, especially with respect to temperatures of more than 750° C., and is suitable for production of corresponding firing aids. Further objects of the disclosure are the provision of a firing aid with the above-described demands and the provision of a corresponding formulation and a production method for production of the material or firing aid.

In one aspect of the disclosure, a formulation is provided, which is suitable in particular for the production of plates and shaped bodies and is pourable.

The formulation comprises a base slip, quartz glass particles and particles of an admixture comprising, in particular, crystallizable or at least partly crystallized multicomponent glass, or green glass or glass-ceramic.

The base slip comprises water as dispersion medium with a proportion between 30% and 50% by weight, preferably 35% and 45% by weight, most preferably 38% and 42% by weight, and ultrafine SiO2 particles/ultrafine SiO2 grains distributed therein with a proportion between 50% and 70% by weight, preferably 55% and 65% by weight, most preferably 58% and 62% by weight. The ultrafine SiO₂ particles are preferably colloidally distributed in the dispersion medium and are also referred to hereinafter as colloidal SiO_{2.} In one embodiment, the ultrafine SiO₂ particles have a particle size distribution D₅₀ in the range from 1 to 3 μm, preferably 1 to 2 μm, and/or a particle size distribution D₉₀ of less than 5 μm, preferably less than 4 μm.

The formulation contains the base slip with a proportion between 15% and 45% by weight, preferably 20% and 40% by weight, most preferably 20% and 35% by weight, quartz glass particles with a proportion between 40% and 70% by weight, preferably 50% and 60% by weight, particles of the admixture comprising at least one green glass or glass-ceramic with a proportion between 0.5% and 37% by weight, for example between 5% and 37% by weight, preferably 7% and 25% by weight, most preferably 9% and 21% by weight. A particularly suitable proportion of the green glass or of the glass-ceramic is in the range from 0.5% to 20% by weight, more preferably 1% to 20% by weight, even further preferably 1% to 10% by weight or 0.5% to 5% by weight. Surprisingly, even these small proportions of green glass, or of the glass-ceramic, in the composite material have a distinct and sufficient effect with regard to structural and dimensional stability.

In one embodiment, the proportion of water in the formulation is 6% to 18% by weight. Corresponding water contents enable good flowability or pourability of the formulation coupled with as high a solids content as possible.

In one embodiment, the composition of the formulation contains 7.5% to 32% by weight, preferably 11% to 26% by weight, of ultrafine SiO₂ particles, quartz glass particles with a proportion between 40% and 70% by weight, preferably 50% and 60% by weight, and particles of the admixture comprising at least one green glass or a glass-ceramic with a proportion between 0.5% and 37% by weight, preferably between 0.5% and 20% by weight, especially between 1% and 20% by weight, more preferably 1% to 10% by weight, especially 0.5% to 5% by weight, or between 5% and 37% by weight, preferably 7% and 25% by weight, most preferably 9% and 21% by weight, and a proportion of water in the range from 6 to 18% by weight.

In an advantageous configuration of the disclosure, the quartz glass particles have a particle size distribution, where the quartz glass particles have a particle size distribution D₅₀ in the range from 30 μm to 500 μm, preferably in the range from 63 μm to 250 μm, and/or a particle size distribution D₉₉ of less than 3.0 mm, preferably less than 2.0 mm and more preferably less than 1.0 mm.

Added to the formulation as admixture are crystallizable glass particles or at least partly crystallized glass particles composed of a multicomponent glass. A multicomponent glass in the context of the disclosure is understood to mean a glass including, as well as SiO₂, at least one further glass-forming constituent. The addition of particles of crystallizable glass, also referred to as green glass, or at least partly crystallized glass, also referred to as glass-ceramic, results in stabilization of a plate produced with the formulation or of a corresponding shaped body even at high temperatures.

A crystallizable glass in the context of this disclosure is especially a glass that can be transformed to crystalline phases to an extent of more than 75% by thermal treatment in the range below, preferably at least 100 K below, the transformation temperature of the matrix glass after max. 24 h. In the present case of a silica glass matrix, the transformation temperature of the matrix glass and hence the upper limit for the thermal treatment is 1130° C. Standard borosilicate glasses, such as, in particular, “borosilicate glass 3.3 according to DIN/ISO 3585”, for example the glasses sold under the DURAN or PYREX brand names, do not meet this condition.

In one embodiment, the particles of multicomponent glass have a particle size distribution with a median particle size D₅₀ in the range from 10 μm to 100 μm, preferably with a median particle size D₅₀ in the range from 15 to 40 μm. Corresponding particle size distributions ensure good processibility, especially good pourability and homogenizability, of the formulation. At the same time, the glass-ceramic phases thus formed in the shaped body are of sufficiently large size to exert a stabilizing effect on the quartz glass framework.

The formulation contains ultrafine SiO₂ particles and water as dispersion medium. The ultrafine SiO₂ particles are distributed preferably colloidally in the dispersion medium and also referred to hereinafter as colloidal SiO_{2.} In one embodiment, the proportion of water in the formulation is 6% to 20% by weight, preferably 10 to 20% by weight. Corresponding water contents enable good flowability or pourability of the formulation with as high a solids content as possible.

In one embodiment, the ultrafine SiO₂ particles have a particle size distribution D50 in the range from 1 to 3 μm and/or a particle size distribution D₉₀ of less than 5 μm, preferably less than 4 μm.

Quartz glass particles are added to the base slip, as are particles of a crystallizable or at least partly crystallized multicomponent glass as admixture. The proportion of quartz glass particles and admixture in the addition to the base slip, in one embodiment, is 70% to 99.5% by weight, preferably 80% to 99% by weight, more preferably 90% to 99% by weight.

In an advantageous configuration of the disclosure, the quartz glass particles have a particle size distribution, where the quartz glass particles have a particle size distribution D₅₀ in the range from 30 μm to 500 μm, preferably in the range from 63 μm to 250 μm, and/or a particle size distribution D99 of less than 3.0 mm, preferably less than 2.0 mm and more preferably less than 1.0 mm.

Added to the formulation as admixture are crystallizable glass particles or at least partly crystallized glass particles of a multicomponent glass. A multicomponent glass in the context of the disclosure is understood to mean a glass including, as well as SiO_{2,} at least one further glass-forming constituent. The proportion of crystallizable or crystallized glass particles in the formulation, in one embodiment, is 0.5% to 37% by weight, preferably 0.5% to 20% by weight, especially 0.5% to 5% by weight, or else 5% to 37% by weight, preferably 7% and 25% by weight, most preferably 9% and 21% by weight. The addition of particles of crystallizable glass, also referred to as green glass, or at least partly crystallized glass, also referred to as glass-ceramic, results in stabilization of a plate produced with the formulation or of a corresponding shaped body even at high temperatures.

In one embodiment, the particles of the multicomponent glass present in the formulation are at least partly crystallized. The at least partly crystallized glass particles have high thermal stability and hence also lead to stabilization of the quartz glass framework, where this framework or this matrix, as well as quartz glass, can also comprise crystalline components, in a shaped body produced with the formulation. Unlike ceramic admixtures, the partly crystallized glass particles of multicomponent glass, also referred to hereinafter as glass-ceramic particles, contain glassy residual phases. These glassy residual phases enable attachment of the partly crystallized glass particles to the quartz matrix, which has an advantageous effect on the stability of a corresponding shaped body.

In a further preferred embodiment, the formulation, alternatively or additionally to the crystallized glass particles, contains particles of crystallizable glass or green glass. In the production of a shaped body, these are converted to glass-ceramic particles in situ and likewise lead to stabilization of the quartz framework. It is advantageous here that the glass particles can first be incorporated particularly efficiently into the quartz framework by virtue of the glassy character of the particles, and the glass particles are subsequently converted to glass-ceramic particles. However, the in situ conversion to a glass-ceramic during the production of a shaped body from the formulation is a more complex production process, especially with regard to the temperature regime, than the production of a shaped body from a formulation comprising already partly crystallized glass particles.

In further embodiments, crystallizable and/or at least partly crystallized glass particles are used, which preferably have the same or a similar composition and/or such crystallizable glass that form at least partly similar or identical crystal phases as present in the respectively used crystallized glass particles. However, the crystallized glass particles added to the formulation and the at least partly crystallized glass particles obtained from the crystallizable glass particles added to the formulation can also differ from one another, i.e., especially also have different compositions. This is effected, for example, in order to adjust thermomechanical properties (e.g. thermal expansion, thermal conductivity or heat capacity or stiffness (modulus of elasticity)) or chemical properties of the composite material, i.e. the shaped body produced from the casting compound formulated.

Formulations having particularly good processibility, in particular high flowability coupled with as high as possible a solids content, can be obtained when the particle size distribution of the quartz glass particles and/or of the particles of the multicomponent glass is multimodal. In one embodiment, quartz glass particles, crystallizable glass particles and/or crystallized glass particles have a bimodal or even trimodal particle size distribution. In one embodiment, the ultrafine SiO2 particles have a monomodal particle size distribution.

In a further development, the Andreassen equation of the size distribution of the totality of the particles of the formulation has a q value in the range from 0.1 to 0.3. In one embodiment, the q value is <0.3 or <0.25. The Andreassen model describes the possibility of filling a space as densely as possible with spherical particles so that the remaining unfilled space is as small as possible but the mixture is nevertheless free-flowing. The use of particles having a broad particle size distribution under this condition can fill a volume with a much higher fill level, i.e. with more particles per unit volume, than in the case of use of particles with a narrow particle distribution or even monodisperse particles. For instance, in the case of particles having a broad particle distribution, the smaller particles can be placed into the cavities that are formed between the larger particles and hence the space can be better exploited. The Andreassen model here defines an idealized particle size distribution with which the maximum fill level of a space with spherical particles can be achieved with simultaneous flowability of the mixture:

$${Q}_{3} ( d ) = {( \frac{d}{D} )}^{q}$$

where d is particle size, D is maximum particle size, and q is a distribution coefficient.

The particle size d is determined as follows: the individual particles of a powder, irrespective of their real shape, are divided into various fractions with reference to the diameter of a sphere having their equivalent volume (volume-equivalent sphere diameter). In order to ascertain the particle distribution Q, the respective number of corresponding fractions within the powder is determined. In the Andreassen equation, the particle distribution Q₃ (d) is used, which is calculated from the volume of the respective fractions.

The q value gives the slope of the Andreassen equation in a log-log plot. The variation in the q value takes account of the variances in the real particles from the ideal model particles. These variances can occur, for example, via a shape of the particles that differs from an ideal sphere or interactions of the particles with one another or with the dispersion medium.

Particles that have a tendency to agglomerate owing to the interaction with the disperse phase show poorer rheological properties at low q values, i.e. would have a high fill level in the case of broad particle size distributions. This is the reason why a higher q value can be advantageous here. With rising q value, however, the mixture becomes coarser and more difficult to process. Mixtures having a high fines content, by contrast, have a low q value.

The inventors have found that, surprisingly, it is possible via the choice of q value to achieve higher fill levels in the formulation of the casting compound. The Andreassen equation of glass particle size distribution has a q value in the range from 0.1 to 0.3. Particularly high maximum volume fill levels are achieved in slips where the Andreassen equation has a q value in the range from 0.1 to 0.25.

For the admixture, suitable powders are those composed of any crystallizable glass systems, especially based on silicate, for example MgO-Al₂O₃-nSiO₂ (MAS), ZnO—Al₂O₃—nSiO₂ (ZAS) or Li₂O—Al₂O₃—nSiO₂ (LAS). It is particularly advantageous here when the admixture is analogous to, i.e. similar to or the same as, a product which is producible, is to be produced or has been produced on or with the firing aid. Thus, for example, if a green glass of a glass-ceramic of the LAS type is to be thermally aftertreated, especially ceramized, a possible admixture as green glass or as glass-ceramic particles is preferably also a corresponding LAS type.

A further aspect of the disclosure relates to a method of producing a shaped body. In this method, the above-described formulation is first provided. This can be obtained, for example, by adding a quartz glass grain fraction and particles of a crystallizable and/or at least partly crystallized multicomponent glass to a base slip. The formulation thus obtained, in a subsequent step, is poured into a mould having porous walls, preferably into a gypsum mould, and dried therein. The use of a mould having porous walls here enables adsorptive uptake of the water present in the formulation through the mould. In conjunction with a relatively low water content in the formulation, it is thus possible to achieve short drying times. Moreover, the use of a formulation with a minimum water content leads to a reduction in shrinkage during drying.

After the at least partial drying, the green body is taken from the mould and optionally dried further and sintered within the temperature range Tₛᵢₙₜₑᵣ from 1000° C. to 1200° C., preferably in the range from 1030° C. to 1180° C. During the sintering process, the SiO₂ particles are sintered together with the green glass particles or partly crystallized glass particles present in the formulation. In embodiments with green glass particles, these are at least partly crystallized during the sintering process at a ceramization temperature T_{ceramization} and converted to a glass-ceramic phase. The ceramization temperature T_{ceramization} is dependent on the respective green glass composition, but is below the sintering temperature Tₛᵢₙₜₑᵣ, so that T_{ceramization}<Tₛᵢₙₜₑᵣ. The sintering temperature Tₛᵢₙₜₑᵣ is less than 1200° C., preferably not more than 1030° C., so that transformation of the quartz glass matrix that forms or is formed into cristobalite is avoided.

The above-described method affords a composite material having a sintered quartz glass matrix and at least partly crystallized glass particles comprising a multicomponent glass that are dispersed therein. The composite material is dimensionally stable, so that it can be mechanically postprocessed. One embodiment of the disclosure therefore provides for a further forming or reworking process after the sintering. This can especially be a grinding, sawing, machining or drilling process.

The at least partly crystallized glass particles of the composite material form at least one glass-ceramic phase, and the proportion of the glass-ceramic phase in the composite material is 0.5% to 30% by volume, preferably 1% to 20% by volume. The at least partly crystallized glass particles dispersed in the quartz matrix result in stabilization of the quartz matrix even at high temperatures. Thus, the composite material in one embodiment can be subjected to higher temperatures than a pure quartz matrix without resulting in deformation of the composite material.

In one embodiment, the at least partly crystallized glass particles in the composite material have a size D₅₀ in the range from 10 μm to 100 μm, preferably in the range from 10 μm to 40 μm. An appropriate size distribution firstly enables a homogeneous distribution of the at least partly crystallized glass particles in the quartz glass matrix. Secondly, the at least partly crystallized glass particles, by virtue of their size, have a sufficiently large glassy phase that can be sintered together with the quartz glass particles and the SiO₂ present in the slip. This leads to good binding of the at least partly crystallized glass particles into the SiO₂ matrix of the composite material.

Glass-ceramic phases have been found to be, in particular, lithium aluminium silicate glass-ceramics (LAS), magnesium aluminium silicate glass-ceramics (MAS) and zinc aluminium silicate glass-ceramics (ZAS). In a preferred embodiment of the disclosure, the composite material has a LAS glass-ceramic phase.

Particularly advantageous composite materials have been found to be those wherein the glass-ceramic phase is crystalline to an extent of 20% to 90% by volume. This level of crystallization has been found to particularly advantageous with regard to the incorporation of the glass-ceramic phases into the composite material, and also to the stabilizing effect of the glass-ceramic phase. The glassy component of the glass-ceramic phase can be sintered together with the quartz glass and thus leads to good binding of the glass-ceramic phases into the quartz matrix.

A high crystallization level has an advantageous effect on the thermal and mechanical stability of the composite material. In one embodiment, the glass-ceramic phase therefore has a crystallization level of at least 30%.

The crystalline phase of the glass-ceramic is also stable with respect to high temperatures, so that, in particular, there are no transformations of the crystalline phase to other modifications. Keatite has been found here to be particularly advantageous as a crystalline phase of the glass-ceramic.

The glass-ceramics used preferably have a low coefficient of thermal expansion. It is thus possible to obtain a composite material having a low coefficient of thermal expansion. This is advantageous especially in the case of use of the composite material as firing aid. In one embodiment, the composite material has a coefficient of thermal expansion ago-3ocrc in the range from 0.01*10⁻⁶ to 1.0*10⁻⁶/K, preferably 0.02*10⁻⁶ to 0.6*10⁻⁶/K.

The composite material, especially in near-surface regions, can contain small amounts of cristobalite. However, this cristobalite content does not lead to an increase in volume, nor is there a harmful phase transformation of cristobalite on cooling of the composite material below 270° C. It can be suspected that the small amounts of cristobalite are stabilized by the glass-ceramic phases. In one embodiment, the composite material in near-surface regions down to a depth of 5 mm, preferably down to a depth of 10 mm, contains up to 1% by volume, preferably more than 0.05% by volume, of cristobalite.

The composite material is porous. In particular, the composite material has a porosity in the range from 6% to 12% by volume, preferably in the range from 8% to 10% by volume. The composite material, by virtue of the composite of glass-ceramic and sintered quartz glass, has particularly high overall stiffness. Thus, in a preferred embodiment, the modulus of elasticity at room temperature is in the range from 18 to 33 GPa. This value is apparent from a bending tensile test for determination of flexural strength at room temperature for refractory products. The high stiffness enables good dimensional stability. Even in the case of loading of the moulds and bases with high weights, deformation remains insignificant. Moreover, the high modulus of elasticity reduces the wall thickness of plates or shaped bodies at a constantly high dimensional stability. This is important not just with regard to the consumption of material in the production of the plates or shaped bodies. For example, when the composite material is used as firing aid, a reduced wall thickness resp. its thickness, i.e. a lower volume with at least similar or improved properties, has the effect that less energy is required on heating. Thus, a lower wall thickness can lead to more energy-efficient processes, especially in the high-temperature processes such as glass or glass-ceramic production. It is thus possible to enable thinner firing aids, for example contact plates, made from the composite material and hence a higher occupation density of a kiln or else shortening of process times.

The composite material is thus especially suitable for use as dimensionally stable high-temperature body or firing aid for ceramization of articles made of green glass. A corresponding firing aid can take the form of a support plate or support bar.

In one embodiment, the composite material is used as support plate or support bar in the ceramization of green glass articles. It has been found here to be particularly advantageous when the glass-ceramic phase in the composite material has essentially the same composition as the green glass to be ceramized. Such compositions are found to be advantageous not just in the ceramization of green glass to give a glass-ceramic, but also in other processes for thermal aftertreatment, for example shaping or decoration, of already ceramized green glasses, i.e. glass-ceramics. It is advantageous here when the firing aid comprises analogous constituents of the material to be subjected to thermal treatment.

Inventive composite materials of this kind can be employed as firing aids not only in the already mentioned use in the ceramization of green glasses to give glass-ceramics as support plate but also in the shaping thereof as mould and/or decoration, including in the already ceramized state. Depending on the use temperature or firing temperature, such firing aids are also usable in the ceramics industry, and also in processes for shaping or forming and/or binding of glasses with glasses or else with other materials, for example glass fusion. In general, the composite material is suitable for use in thermal processes up to temperatures of about 1200° C. The ceramized green glass placed onto the firing aid forms a unit together with the firing aid. In general, this disclosure, for this purpose, envisages a unit comprising a support plate or support bar composed of a composite material according to this disclosure and a green glass or glass-ceramic article, preferably a green glass or glass-ceramic sheet, wherein at least some regions of the support plate or support bar and of the article have a common interface, and wherein the compositions of the glass-ceramic phase of the composite material of the support plate or support bar and of the glass-ceramic article differ by a maximum of 10% by weight with regard to the content of the individual constituents, differ at most by a factor of 2 for glass or glass-ceramic constituents having a content of less than 10% by weight, and/or the two compositions have constituents that differ by a maximum of 10% by weight, where the composite material and the glass-ceramic article preferably have the same composition. A corresponding unit is also formed with the composite material and the green glass placed thereon, for example that which is still to be ceramized.

A composite material according to the disclosure can also be used in the field of glass melts and/or the accompanying hot shaping. In addition, use of such a composite material in metal melting is also conceivable in a similar manner to that with regard to glass melting and the further processing thereof.

As well as the above-described high stiffness to elastic deformation because of a high loading or as a result of intrinsic weight, resistance to plastic deformation at high-temperature is important. One embodiment envisages a firing aid composed of the composite material, wherein the firing aid takes the form of a planar support plate or support bar and maximum deformation under a flexural stress of 0.5 N/mm² over a length of the support plate orthogonally to the direction of pressure of 200 mm under simultaneous thermal stress at 1130° C. over 12 hours is less than 5 mm, preferably less than 3 mm and more preferably less than 2 mm.

### BRIEF DESCRIPTION OF THE DRAWINGS

The disclosure is described in detail hereinafter with reference to FIGS. 1 to 7 and with reference to working examples.

FIGS. 1 and 2 show a schematic diagram of the composite material.

FIG. 3 shows a schematic diagram of a firing aid in the form of a support bar.

FIG. 4 shows a schematic diagram of a firing aid in the form of a support plate.

FIG. 5 shows the schematic diagram of a deformation test.

FIGS. 6 and 7 show photographs of a working example and a comparative example after performance of the deformation test.

FIG. 8 shows a diagram for illustration of the low deformation of the firing aids according to the disclosure after stress by comparison with conventional materials based on pure fused silica.

### DETAILED DESCRIPTION OF THE DISCLOSURE

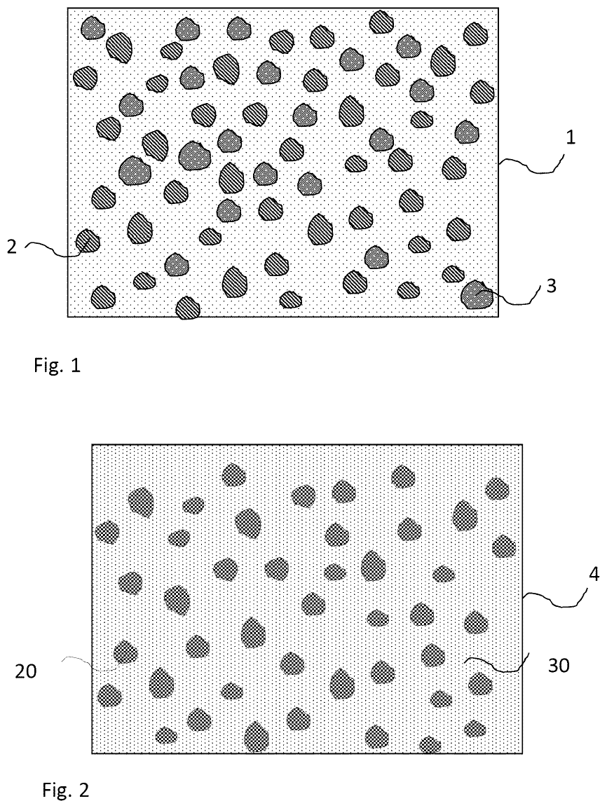

FIG. 1 shows the schematic diagram of a formulation 1 according to a first working example. The formulation 1 comprises a base slip, quartz glass particles and particles of crystallizable multicomponent glass.

The base slip comprises water as dispersion medium with a content between 30% and 50% by weight, preferably 35% and 45% by weight, most preferably 38% and 42% by weight, and ultrafine SiO2 particles, distributed preferably colloidally therein with a proportion between 50% and 70% by weight, preferably 55% and 65% by weight, most preferably 58% and 62% by weight. The crystallizable glass 3 is a multicomponent glass, preferably a crystallizable glass, also referred to as green glass, composed of lithium aluminium silicate (LAS type). The median particle size D50 of the crystallizable glass, in the working example shown in FIG. 1, is in the range from 20 to 35 μm. The quartz glass particles have a median particle size D₅₀ in the range from 63 μm to 250 μm. The particle size distributions of green glass and quartz glass are preferably chosen so that the mixture is defined by an Andreassen equation with a q value less than 0.3.

The green glass 3 has a ceramization temperature below 1200° C. Thus, the ceramization temperature of green glass 3 is below the sintering temperature for sintering of the quartz glass particles. This enables ceramization of the green glass 3 during the sintering of the quartz glass content. It is possible here to sinter the glassy phase of the glass-ceramic regions together with the quartz glass, so that particularly stable binding can be achieved between the sintered fused silica matrix and the glass-ceramic phases dispersed therein. The formulation is heated here to a temperature corresponding at least to the temperature at which the firing aid obtained from formulation 1 is to be used. In the working example shown in FIG. 1, a corresponding firing aid is produced by pouring the formulation 1 into a mould having porous walls. The water content of the formulation can be absorbed through the porous walls, so that a stable green body is obtained. For sintering, the green body is heated to a temperature corresponding at least to the temperature at which the firing aid thus formed is to be used.

FIG. 2 shows a schematic of the composite material 4 produced by sintering the formulation shown in FIG. 1. The sintering transforms the quartz glass particles 2 and the slip to a quartz matrix 30. The green glass particles 2 were transformed to the glass-ceramic phases 20. The composite material 4 is thus formed by a sintered fused silica matrix 30 in which glass-ceramic phases 20 are dispersed. In the example shown in FIG. 2, the composite material 4 has a proportion of glass-ceramic phases 20 in the range from 5% to 30% by volume. The glass-ceramic phases 20 are an LAS glass-ceramic. The glass-ceramic phases 20 have a crystallization level of at least 30% by volume, preferably a crystallization level in the range from 60% to 90% by volume, where the crystalline phases take the form of keatite. Keatite is stable here even at high temperatures, i.e. at temperatures above 1180° C. This allows the sintered fused silica matrix 30 to be stabilized at high temperatures, and transformation of the sintered fused silica matrix to cristobalite to be prevented or at least reduced. The composite material preferably has a cristobalite content of less than 5% by volume. The composite material 4 can have pores, but these are not shown in FIG. 2.

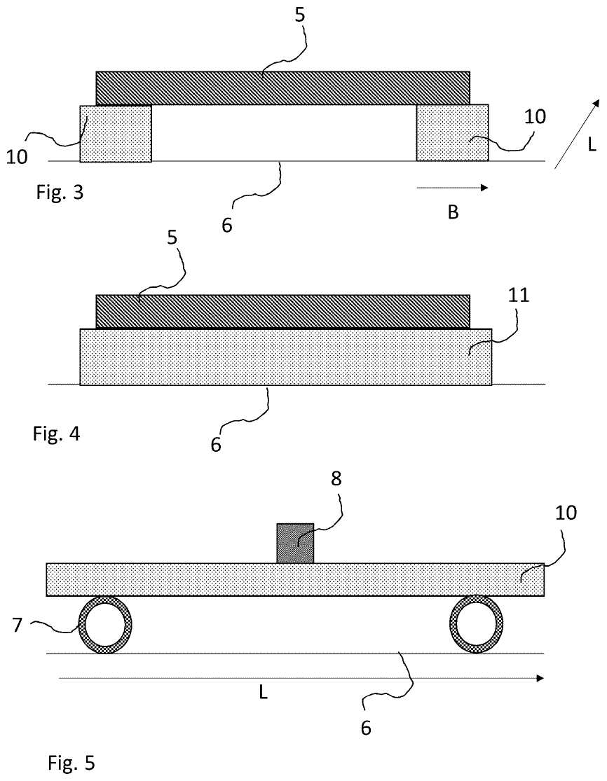

FIGS. 3 and 4 show the use of the composite material 4 as firing aid 10, 11. The firing aid 10 shown in FIG. 3 takes the form of a bar having a width B and a length L, where the length L is greater than the width B. The firing aids 10 are positioned on the kiln bottom 6 and serve as base for the green glass sheet 5. The green glass sheet 5 here lies on the bars 10 only in their edge regions. FIG. 4 shows an embodiment in which the firing aid 11 takes the form of a plate. The green glass sheet 5 here lies over the full surface of the plate 11. The green glass sheet 5 advantageously has the same composition as the glass-ceramic phases of the firing aid 10, 11.

The firing aids according to the disclosure show high trueness of shape.

FIG. 5 shows the schematic structure for determining permanent deformation resulting from thermomechanical stress on the firing aid 10. In this case, for example, a 200 mm-long piece of the firing aid material 10 is placed on two refractory spacers 7, with only the edge regions of the firing aid 10 lying on the spacers 7. A weight 8 is placed in the middle of the firing aid 10, as a result of which the firing aid 10 is subjected to a maximum flexural stress of

0.5 N/mm². The arrangement shown in FIG. 5 is kept at 1130° C. for 5 days. Subsequently, the lasting deformation of the firing aid 10 is determined. The deformation of firing aids with the same dimensions was likewise determined, except made from pure sintered fused silica, i.e. without glass-ceramic phases, as comparative examples.

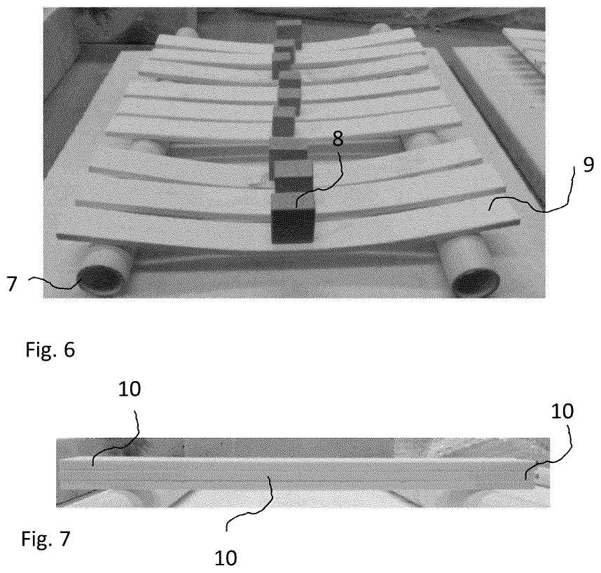

FIG. 6 shows a photograph of essentially pure sintered fused silica bars 9 after the above-described bending test. Even by the naked eye, clear deformation of the quartz bars is apparent. FIG. 7 shows three bars 10 of the composite material of the disclosure, which have been subjected to the same conditions as the sintered fused silica bars shown in FIG. 6. None of the three bars shows a distinct variance in shape. Instead, the bars 10 have a deformation of less than 2 mm per 200 mm.

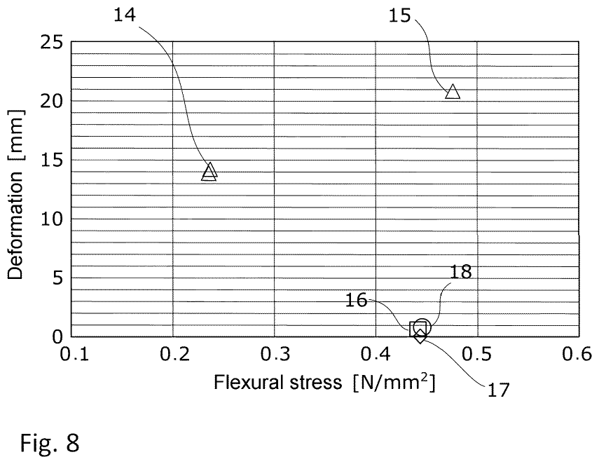

FIG. 8 shows deformation as a function of flexural stress. Samples 14 to 15 are comparative examples composed of essentially pure fused silica; samples 16, 17, 18 are working examples of firing aids of the disclosure. All samples were subjected to a flexural stress of 0.5 N/mm² at 1130° C. for 12 hours. Sample 16 contains 10% by volume, sample 17 contains 15% by volume, and sample 18 contains 20% by volume, of glass-ceramic phases.

It becomes clear from FIG. 8 that Comparative Examples 14 and 15 have considerable deformations. Deformation rises here with rising flexural stress. It can be assumed that, in the sintered fused silica bars, there is gradual deformation of the glassy and hence viscous connection sites between the individual silica glass grains in the bars. The combination with glass-ceramic phases, by contrast, results in preferential incorporation of a crystalline phase at these connection sites. Since this is not viscous, the corresponding bars 16, 17, 18 do not show deformation on thermal treatment. In further exploratory tests, it has been found that even very small proportions of glass-ceramic phases distinctly reduce deformation under thermomechanical stress compared to pure sintered fused silica.

### LIST OF REFERENCE NUMERALS

1 formulation
2 partly crystallized glass particles of multicomponent glass
3 quartz glass particles
4 composite material
5 glass-ceramic sheet
6 kiln bottom
7 spacer
8 weight
10 firing aid in bar form
11 firing aid in plate form
14, 15 sintered fused silica bar, pure SiO2 without ceramic phases
16 sintered fused silica bar with 10% by volume of at least partly crystallized glass particles of multicomponent glass
17 sintered fused silica bar with 15% by volume of at least partly crystallized glass particles of multicomponent glass
18 sintered fused silica bar with 20% by volume of at least partly crystallized glass particles of multicomponent glass
20 glass-ceramic phase
30 sintered fused silica or sintered quartz matrix

What is claimed is:

1. A formulation for producing plates and shaped bodies, the formulation comprising:
a base slip;
quartz glass particles; and
multicomponent glass particles that are crystallizable or at least partly crystallized,
wherein the proportion of the base slip in the formulation is 15% to 45% by weight, the base slip contains water as dispersion medium with a content between 30% and 50% by weight of the base slip and ultrafine SiO2 particles distributed colloidally therein with a proportion between 50% and 70% by weight of the base slip,
wherein the proportion of quartz glass particles in the formulation is 40% to 70% by weight, and
wherein the proportion of multicomponent glass particles in the formulation is

0. 5% to 37% by weight.

2. The formulation according to claim 1, wherein:
the quartz glass particles have a particle size distribution D₅₀ in a range from 30 μm to 500 μm, and/or
the quartz glass particles have a particle size distribution D₉₉ of less than 3.0 mm.

3. The formulation according to claim 1, wherein the quartz glass particles and/or the multicomponent glass particles have a particle size distribution that is multimodal.

4. The formulation according to claim 1, wherein all the particles present in the formulation have a size distribution that conforms to an Andreassen equation:
$${Q}_{3} ( d ) = {( \frac{d}{D} )}^{q}$$
where d is particle size, D is maximum particle size, and q is a distribution coefficient,
wherein q<0.3.

5. The formulation according to claim 1, wherein the multicomponent glass particles are configured to be converted to a magnesium aluminium silicate (MAS) glass-ceramic phase, to a zinc aluminium silicate (ZAS) glass-ceramic phase, or to a lithium aluminium silicate (LAS) glass-ceramic phase.

6. The formulation according to claim 1, wherein the multicomponent glass particles are glass-ceramic or green glass particles having a median particle size D₅₀ a range from 10 μm to 100 μm.

7. The formulation according to claim 1, wherein the proportion of the multicomponent glass particles in the formulation is 0.5% to 20% by weight.

8. The formulation according to claim 1, wherein the multicomponent glass particles have a ceramization temperature T_{ceramization} of less than 1200° C.

9. A composite material, comprising:
a sintered quartz glass matrix; and
a glass-ceramic phase,
wherein the proportion of the glass-ceramic phase in the composite material is 0.5% to 30% by volume of the composite material.

10. The composite material according to claim 9, wherein the glass-ceramic phase has individual glass-ceramic particles having a size D₅₀ that ranges from 10 μm to 100 μm.

11. The composite material according to claim 9, wherein the proportion of the glass-ceramic phase in the composite material is 1% to 20% by volume of the composite material.

12. The composite material according to claim 9, wherein the glass-ceramic phase comprises a lithium aluminium silicate (LAS), magnesium aluminium silicate (MAS), and/or zinc aluminium silicate (ZAS) glass-ceramic.

13. The composite material according to claim 9, wherein the composite material has a coefficient of thermal expansion α_{20-300° C.} that ranges from 0.01*10⁻⁶ to 1.0*10⁻⁶/K, a porosity that ranges from 6% to 12% by volume of the composite material, and/or a modulus of elasticity at room temperature that ranges from 18 GPa to 33 GPa.

14. The composite material according to claim 9, wherein the glass-ceramic phase has a crystallization level that ranges from 20% to 90% of the composite material.

15. The composite material according to claim 9, wherein the composite material contains up to 1% by volume cristobalite in a region from a surface of the composite material to a depth of 5 mm.

16. The composite material according to claim 9, wherein the composite material is configured to be mechanically reworked by a drilling, a sawing, or a grinding process.

17. A method for producing a composite material, the method comprising the following steps:
a) providing a formulation to yield a casting compound, the formulation comprising:
a base slip;
quartz glass particles; and
multicomponent glass particles that are crystallizable or at least partly crystallized,
wherein the proportion of the base slip in the formulation is 15% to 45% by weight, the base slip contains water as dispersion medium with a content between 30% and 50% by weight of the base slip and ultrafine SiO₂ particles distributed therein with a proportion between 50% and 70% by weight of the base slip,
wherein the proportion of quartz glass particles in the formulation is 40% to 70% by weight, and
wherein the proportion of multicomponent glass particles in the formulation is 0.5% to 37% by weight; and
b) providing a casting mould with porous walls;
c) pouring the casting compound into the casting mould so the porous walls can absorb the water to yield a green body that is dimensionally stable;
d) removing the green body from the mould;
e) heating the green body to a sintering temperature Tₛᵢₙₜₑᵣ that ranges from 1000° C. to 1200° C. so that the ultrafine SiO₂ particles are sintered together with the multicomponent glass particles, and so that the multicomponent glass particles are at least partly converted to a glass-ceramic phase at a ceramization temperature Tceramization where T_{ceramization}<Tₛᵢₙₜₑᵣ to yield the composite material.

18. The method according to claim 17, further comprising: mechanically processing the composite material by drilling, machining, or grinding.

19. The method according to claim 17, wherein the formulation comprises a lithium aluminium silicate (LAS), magnesium aluminium silicate (MAS), and/or zinc aluminium silicate (ZAS) glass-ceramic particles.

20. A product comprising the composite material according to claim 9, wherein the product is a structure selected from the group consisting of: a support plate, a support bar, a dimensionally stable high-temperature body, a firing aid for ceramization of articles made of green glass, and an aftertreatment of articles made of glass-ceramic.

21. The product according to claim 20, where in the product is the firing aid, wherein the firing aid is formed as a planar support plate, and after thermal stressing at 1130° C. over a period of 12 hours with a flexural stress of 0.5 N/mm² over a 200 mm length of the support plate orthogonal to a direction of pressure, the firing aid has a maximum deformation of less than 5 mm.

22. A unit comprising:
a support plate or bar made of the composite material according to claim 9; and
a green glass or a glass-ceramic article,
wherein the support plate or bar and of the glass-ceramic article each have region with a common interface,
wherein the support plate or bar and the glass-ceramic article differ have glass-ceramic phases with a composition that differs by a maximum of 10% by weight with regard to a content of individual constituents, by at most a factor of 2 for glass or glass-ceramic constituents having a content of less than 10% by weight, and/or the compositions have constituents that differ by a maximum of 10% by weight,
wherein the composite material and the glass-ceramic article have an identical composition.
